(19) United States
(12) Patent Application Publication
(10) Pub. No.: US 2009/0213011 A1
(43) Pub. Date: Aug. 27, 2009

(54) Dual-band dual-feed antenna

(75) Inventors: Tiao-Hsing Tsai, Tao Yuan Shien (TW); Chieh-Ping Chiu, Tao Yuan Shien (TW); Chih-Wei Liao, Tao Yuan Shien (TW); Peng-Jen Weng, Tao Yuan Shien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Quanta Computer Inc., Kuei Shan Hsiang (TW)

(21) Appl. No.: 12/231,711

(22) Filed: Sep. 4, 2008

(30) Foreign Application Priority Data
Feb. 25, 2008 (TW) 097106426

(51) Int. Cl. H01Q 1/38

(52) U.S. Cl. 343/700 MS

(57) ABSTRACT

An antenna includes an open loop conductor, a pair of feeding points, and a conductive arm. The open loop conductor includes a loop element that has opposite first and second ends, and first and second feeding elements, each of which is connected to a respective one of first and second ends of the loop element. Each of the feeding points is provided on a respective one of the first and second feeding elements. The conductive arm extends from the open loop conductor.

### CROSS-REFERENCES TO RELATED APPLICATION

This application claims priority to Taiwanese Application No. 097106426, filed Feb. 25, 2008, the disclosure of which is herein incorporated by reference.

### BACKGROUND OF THE INVENTION

1. Field of the Invention

This invention relates to an antenna, more particularly to a dual-band dual-feed antenna.

2. Description of the Related Art

A conventional dual-band antenna device includes a pair of antennas and a switching unit. Each of the antennas operates in a distinct frequency band. The switching unit, such as that of disclosed in Taiwanese Patent Application No. 94121118, selectively connects a transceiver of an electronic device to one of the antennas. The conventional dual-band antenna, however, consumes a large amount of power and has high manufacturing costs. Moreover, impedance matching for the conventional dual-band antenna is difficult to accomplish.

To solve the aforementioned problem, it has been proposed to use a dual-band dual-feed antenna, which is disclosed in Taiwanese Patent Application Publication No. 200638605. As illustrated in FIG. 1, the conventional dual-band dual-feed antenna 80 includes a pair of radiating elements 83, 84, each of which operates in a distinct frequency band, and a pair of feeding points 81, 82, each of which is provided on a respective one of the radiating elements 83, 84. The conventional dual-band dual-feed antenna, however, has a relatively large physical size.

### SUMMARY OF THE INVENTION

Therefore, the object of the present invention is to provide an antenna that can overcome the aforesaid drawbacks of the prior art.

According to the present invention, an antenna comprises an open loop conductor, a pair of feeding points, and a conductive arm. The open loop conductor includes a loop element, and first and second feeding elements. The loop element has opposite first and second ends. Each of the first and second feeding elements is disposed outside of the loop element and has opposite first and second ends. The first end of each of the first and second feeding elements is connected to a respective one of the first and second ends of the loop element. Each of the feeding points is provided on the second end of a respective one of the first and second feeding elements. The conductive arm extends from the open loop conductor.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional dual-band dual-feed antenna;

FIG. 2 is a perspective view of the preferred embodiment of an antenna according to this invention;

FIG. 3 is a perspective view illustrating dimensions of the preferred embodiment;

FIG. 4 is a plot illustrating a voltage standing wave ratio (VSWR) of the preferred embodiment when operated at b 2.1 GHz;

FIG. 5 is a plot illustrating a VSWR of the preferred embodiment when operated at 2.4 GHz;

FIG. 6 shows plots of radiation patterns of the preferred embodiment respectively on the x-y, x-z, and y-z planes when operated at 2140 MHz; and

FIG. 7 shows plots of radiation patterns of the preferred embodiment respectively on the x-y, x-z, and y-z planes when operated at 2442 MHz.

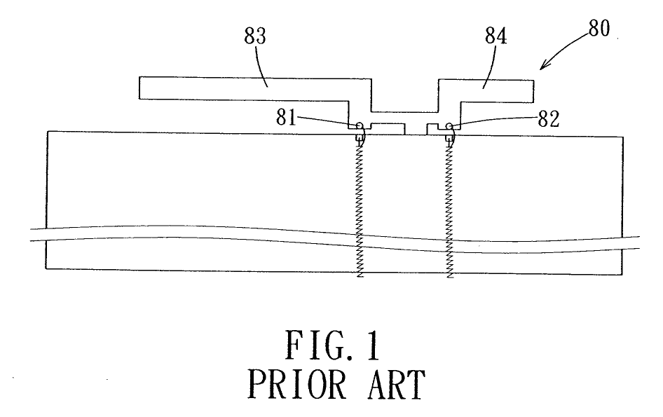

### DETAILED DESCRIPTION OF THE PREFERRED EMBODIMENT

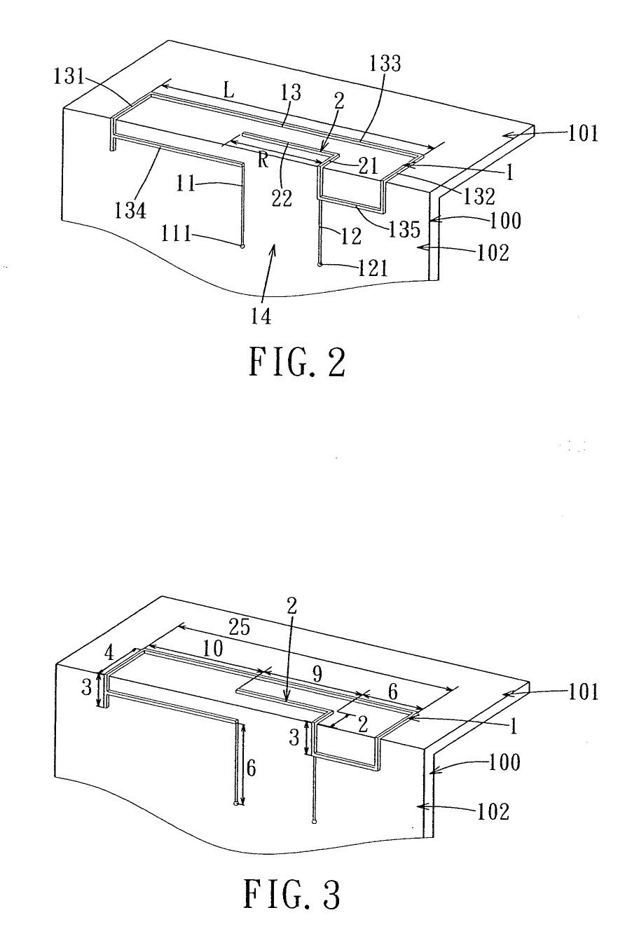

Referring to FIG. 2, the preferred embodiment of an antenna according to this invention is shown to include an open loop conductor 1, first and second feeding points 111, 121, and a conductive arm 2.

The open loop conductor 1 has a loop opening 14, and includes a loop element 13, and first and second feeding elements 11, 12.

The loop element 13 of the open loop conductor 1 includes first, second, third, fourth, and fifth segments 131, 132, 133, 134, 135. Each of the first and second segments 131, 132 has opposite first and second ends. The third segment 133 extends transversely to the first and second segments 131, 132 and interconnects the first ends of the first and second segments 131, 132. The fourth segment 134 extends transversely from the first segment 131, and has a first end, and a second end that is opposite to the first end thereof and that is connected to the second end of the first segment 131. The fifth segment 135 extends transversely from the second segment 132, and has a first end that is connected to the second end of the second segment 132, and a second end that is opposite to the first end thereof. In this embodiment, the fourth and fifth segments 134, 135 extend toward each other.

The first feeding element 11 of the open loop conductor 1 is disposed outside of the loop element 13, extends transversely from the fourth segment 134 of the loop element 13 away from the third segment 133 of the loop element 13, and has a first end connected to the first end of the fourth segment 134 of the loop element 13, and a second end opposite to the first end thereof.

The second feeding element 12 of the open loop conductor 1 is disposed outside of the loop element 13, extends transversely from the fifth segment 135 of the loop element 13 away from the third segment 133 of the loop element 13, and has a first end connected to the second end of the fifth segment 135 of the loop element 13, and a second end opposite to the first end thereof.

In this embodiment, the first and second feeding elements 11, 12 cooperatively define the loop opening 14 in the open loop conductor 1 therebetween.

Each of the first and second feeding points 111, 121 is provided on the second end of a respective one of the first and second feeding elements 11, 12. In this embodiment, each of the first and second feeding points 111, 121 may be connected to a transceiver (not shown) of an electronic device (not shown) through a transmission line (not shown).

The conductive arm 2 is disposed inside of the loop element 13 of the open loop conductor 1, is generally L-shaped, and includes first and second segments 21, 22. The first segment 21 of the conductive arm 2 extends from a junction of the second end of the fifth segment 135 of the loop element 13 and the first end of the second feeding element 12 of the open loop conductor 1 toward the third segment 133 of the loop element 13 of the open loop conductor 1. The second segment 22 of the conductive arm 2 extends from the first segment 21 of the conductive arm 2 toward the first segment 131 of the loop element 13 of the open loop conductor 1, is parallel to the third segment 133 of the loop element 13 of the open loop conductor 1, and is registered with the loop opening 14 in the open loop conductor 1. The construction as such enhances a coupling between the third segment 133 of the loop element 13 of the open loop conductor 1 and the second segment 22 of the conductive arm 2.

The antenna of this invention is mounted on a dielectric substrate 100, and is folded such that a portion of the first segment 131, a portion of the second segment 132, and the third segment 133 of the loop element 13 of the open loop conductor 1, and a portion of the first segment 21, and the second segment 22 of the conductive arm 2 are coplanar on a first plane 101, and such that the remaining portion of the first segment 131, the remaining portion of the second segment 132, and the fourth and fifth segments 134, 135 of the loop element 13 of the open loop conductor 1, the remaining portion of the first segment 21 of the conductive arm 2, the first and second feeding elements 11, 12, and the first and second feeding points 111, 112 are coplanar on a second plane 102 transverse to the first plane 101. The construction as such reduces the physical size of the antenna of this invention.

In this embodiment, the antenna of this invention operates at an operating frequency of 2.1 GHz when the first feeding point 111 thereof is connected to the transceiver of the electronic device. On the other hand, the antenna of this invention operates at an operating frequency of 2.4 GHz when the second feeding point 121 thereof is connected to the transceiver of the electronic device. Moreover, in this embodiment, the antenna of this invention has an input impedance of 50 Ohms when looking into either the first or second feeding points 111, 121.

It is noted that the third segment 133 of the loop element 13 of the open loop conductor 1 has, a length (L) that may be lengthened or shortened to adjust the operating frequency of the antenna of this invention. Moreover, the second segment 22 of the conductive arm 2 has a length (R) that may be lengthened or shortened to adjust the input impedance of the antenna of this invention. As such, the input impedance of the antenna of this invention may be matched to an impedance of the transmission line by simply altering the length (R) of the second segment 22 of the conductive arm 2.

In this embodiment, each of the open loop conductor 1 and the conductive arm 2 has a width of 1 centimeter. Moreover, in this embodiment, as best shown in FIG. 3, each of the first and second segments 131, 132 of the loop element 13 of the open loop conductor 1 has a length of 7 centimeters, the length (L) of the third segment 133 of the loop element 13 of the open loop conductor 1 is 25 centimeters, and each of the first and second feeding elements 11, 12 of the open loop conductor 1 has a length of 6 centimeters. Further, in this embodiment, the first segment 21 of the conductive arm 2 has a length of 5 centimeters, and the length (R) of the second segment 22 of the conductive arm 2 is 9 centimeters. In addition, in this embodiment, the loop opening 14 in the open loop conductor 1 has a width of 7 centimeters.

It is noted that, the portion of each of the first and second segments 131, 132 of the loop element 13 of the open loop conductor 1, which lies on the first plane 101, has a length of 4 centimeters, the remaining portion of each of the first and second segments 132, 132 of the loop element 13 of the open loop conductor 1, which lies on the second plane 102, has a length of 3 centimeters, the portion of the first segment 21 of the conductive arm 2, which lies on the first plane 101, has a length of 2 centimeters, and the remaining portion of the first segment 21 of the conductive arm 2, which lies on the second plane 102, has a length of 3 centimeters. Moreover, the first segment 131 of the loop element 13 of the open loop conductor 1 and the second segment 22 of the conductive arm 2 define a distance of 10 centimeters therebetween. Further, the second segment 132 of the loop element 13 of the open loop conductor 1 and the second segment 22 of the conductive arm 2 define a distance of 6 centimeters therebetween.

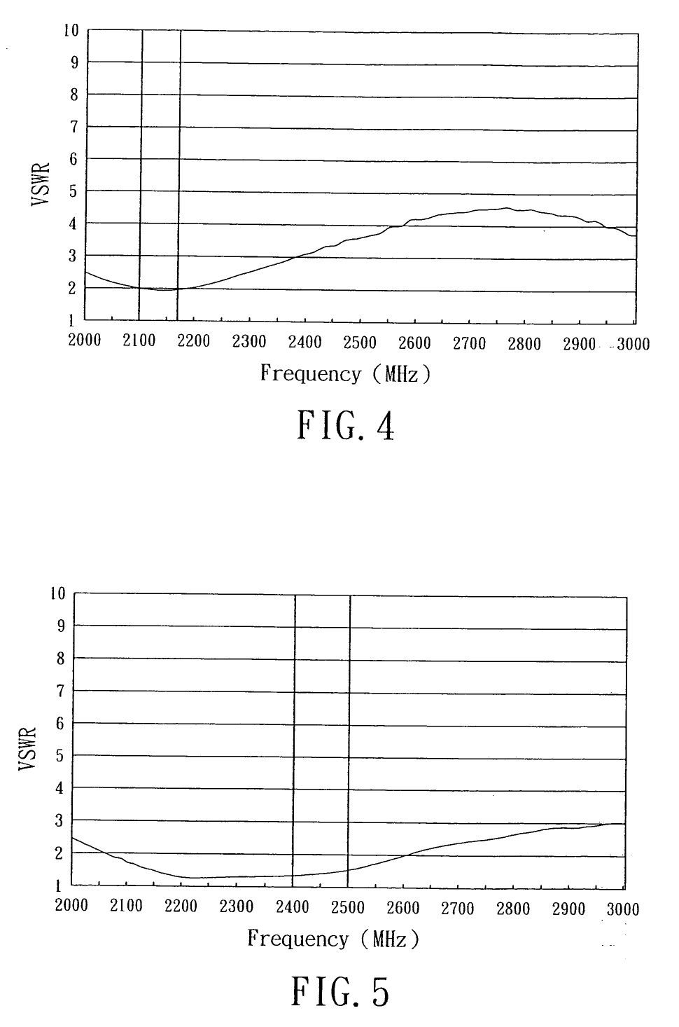

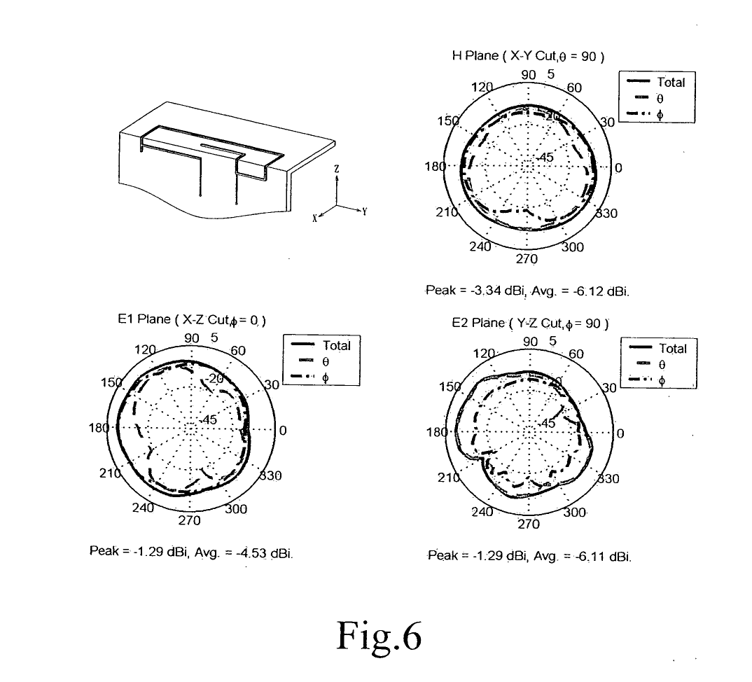

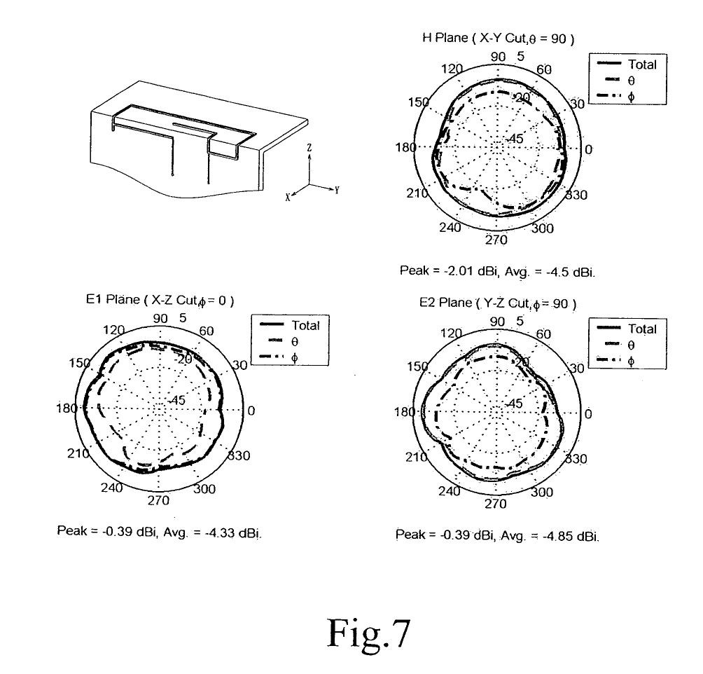

Experimental results, as illustrated in FIGS. 4 and 5, show that the antenna of this invention achieves a voltage standing wave ratio (VSWR) of less than 2.0 when operated at the operating frequencies of 2.1 GHz and 2.4 GHz, respectively. Moreover, as illustrated in FIGS. 6 and 7, the antenna of this invention has a substantially omnidirectional radiation pattern when operated at 2140 MHz and 2442 MHz, respectively.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An antenna comprising:
an open loop conductor including
a loop element that has opposite first and second ends, and
first and second feeding elements, each of which is disposed outside of said loop element and has opposite first and second ends, said first end of each of said first and second feeding elements being connected to a respective one of said first and second ends of said loop element;
a pair of feeding points, each of which is provided on said second end of a respective one of said first and second feeding elements; and
a conductive arm extending from said open loop conductor.

2. The antenna as claimed in claim 1, wherein said conductive arm extends from a junction of said second end of said loop element and said first end of said second 1feeding element of said open loop conductor.

3. The antenna as claimed in claim 1, wherein said conductive arm is disposed inside of said loop element of said open loop conductor.

4. The antenna as claimed in claim 3, wherein said loop element of said open loop conductor includes a segment, and said conductive arm includes a segment parallel to said segment of said loop element of said open loop conductor.

5. The antenna as claimed in claim 3, wherein said conductive arm includes
a first segment that extends from a junction of said second end of said loop element and said first end of said second feeding element of said open loop conductor, and
a second segment that extends from said first segment thereof.

6. The antenna as claimed in claim 5, wherein said loop element of said open loop conductor includes a segment, and said second segment of said conductive arm is parallel to said segment of said loop element of said open loop conductor.

7. The antenna as claimed in claim 5, wherein said open loop conductor has a loop opening, and said second segment of said conductive arm is registered with said loop opening in said open loop conductor.

8. The antenna as claimed in claim 7, wherein said first and second feeding elements of said open loop conductor cooperatively define said loop opening in said open loop conductor therebetween.

9. The antenna as claimed in claim 1, wherein said conductive arm is generally L-shaped.

10. The antenna as claimed in claim 1, wherein the antenna has an input impedance of 50 Ohms.
